(19) United States
(12) Patent Application Publication
(10) Pub. No.: US 2024/0343894 A1
(43) Pub. Date: Oct. 17, 2024

(54) POLYMER MASTERBATCH AND LLDPE COMPOSITIONS CONTAINING HIGH MOLECULAR WEIGHT ETHOXYLATES

(71) Applicant: LyondellBasell Advanced Polymers Inc., Houston, TX (US)

(72) Inventor: Melanie Longanecker, Akron, OH (US)

(73) Assignee: LyondellBasell Advanced Polymers Inc., Houston, TX (US)

(21) Appl. No.: 18/634,566

(22) Filed: Apr. 12, 2024

Related U.S. Application Data
(60) Provisional application No. 63/459,109, filed on Apr. 13, 2023.

(51) Int. Cl. C08L 23/06; C08J 3/00; C08J 5/18; C08K 3/32; C08K 5/13; C08L 23/12; C08L 23/14

(52) U.S. Cl. CPC C08L 23/06; C08J 3/005; C08J 5/18; C08L 23/12; C08L 23/14; C08J 2323/06; C08J 2323/12; C08J 2323/14; C08K 3/32; C08K 5/13; C08K 2201/012; C08L 2205/08; C08L 2207/066; C08L 2310/00

(57) ABSTRACT

Provided are linear low density polyethylene (LLDPE) compositions including a LLDPE polymer and from 100 ppm to 10,000 ppm of a high molecular weight ethoxylate polymer processing aid (PPA) that is substantially free of fluorine-containing compounds. Also provided are polyolefin masterbatches including from 1 wt. % to 50 wt. % of such inventive high molecular weight ethoxylate PPAs and methods of decreasing melt fracture % in linear low density polyethylene films by blending such high molecular weight ethoxylate polymer processing aids and polyolefin masterbatches into cast films and blown films during extrusion processing.

### PRIOR RELATED APPLICATIONS

This application claims the benefit of priority to U.S. Provisional Application No. 63/459,109, filed on Apr. 13, 2023, which is incorporated herein by reference in its entirety.

### FIELD OF THE INVENTION

The present disclosure relates to linear low density polyethylene (LLDPE) compositions containing high molecular weight ethoxylate polymer processing aids and the methods of making the same. More particularly, the present disclosure relates to linear low density polyethylene (LLDPE) compositions, including blown and cast films, containing high molecular weight ethoxylates polymer processing aids that are substantially free of fluoropolymer compounds and methods of making and using the same.

### BACKGROUND OF THE INVENTION

Linear low density polyethylene (LLDPE) is a substantially linear polymer, with significant numbers of short branches, commonly made by copolymerization of ethylene with higher alpha-olefins such as butene, hexene, or octene. LLDPE differs structurally from conventional low density polyethylene (LDPE) because of the absence of long chain branching. LLDPE polymers are commonly produced and sold as pellets or resin, formed in post-polymerization reactor finishing processes (such as extrusion of polymer product that is in an at least partially molten state, followed by pelletization). Additives are commonly blended into the LLDPE pellets or resin as part of this finishing process, such that the LLDPE pellets or resin comprise the LLDPE polymer itself and one or more additives. One of the more common uses of LLDPE resin is the extrusion into blown films and cast films.

Polymer processing aids (PPAs) are a typical additive used in LLDPE resin products. PPAs help make the resin easier to process in downstream manufacturing processes (such as extrusion, rolling, blowing, casting, and stretching). PPAs also help to eliminate melt fracture (as defined below) in blown and cast films made from the LLDPE resin as well as reducing die build up in the same. This is particularly important for grades of LLDPE resins exhibiting relatively higher viscosity in extrusion processing. Melt fracture can adversely affect LLDPE film properties, distort clarity, and reduce gauge uniformity as well as decrease extrusion process productivity. Hence, melt fracture-prone grades of LLDPE for blown film and cast film processing often include PPAs to help eliminate melt fracture, and improve film quality and productivity.

The most common PPAs are, or include, fluoropolymers (fluorine-containing polymers). However, fluoropolymers continue to come under increased scrutiny from an environmental and health perspective. In particular, perfluoroalkyl and polyfluoroalkyl materials are being phased out and/or regulated out of use in many industries. Hence, there is a need to find alternative PPAs that do not include fluoropolymers and/or fluorine for use in LLDPE compositions, while still maintaining the effectiveness of fluoropolymer-based PPAs in preventing melt fractures during blown film processing, cast film processing and other polymer manufacturing processes.

### SUMMARY OF THE INVENTION

In one form of the present disclosure, provided is a linear low density polyethylene (LLDPE) composition comprising a LLDPE polymer and from 100 ppm to 10,000 ppm of a polymer processing aid (PPA) that is substantially free of fluorine-containing compounds, wherein the polymer processing aid is a high molecular weight ethoxylate.

In another form of the present disclosure, provided is a polyolefin masterbatch comprising a polyolefin polymer as a carrier resin and from 1 wt. % to 50 wt. % of a polymer processing aid (PPA) that is substantially free of fluorine-containing compounds, wherein the polymer processing aid is a high molecular weight ethoxylate.

In yet another form of the present disclosure, provided is a method of decreasing melt fracture in linear low density polyethylene films comprising: extruding a linear low density polyethylene resin into a blown film or cast film on an extrusion line; and blending into the extrusion line a polymer processing aid (PPA) that is substantially free of fluorine-containing compounds to provide from 100 ppm to 10,000 ppm of the polymer processing aid (PPA) in the blown film or cast film, wherein the polymer processing aid is a high molecular weight ethoxylate; and wherein the blown film or cast film is such that at 90 minutes of forming the blown film or cast film, % melt fracture (on basis of area of the film's surface) is less than equal to 35%. The polymer processing aid may be directly blended into the extrusion line or blended into the extrusion line as a masterbatch.

In yet another form of the present disclosure, provided is a method of decreasing melt fracture in linear low density polyethylene films comprising: blending a polymer processing aid (PPA) that is substantially free of fluorine-containing compounds to provide from 100 ppm to 10,000 ppm of the polymer processing aid (PPA) into a linear low density polyethylene resin in a post-polymerization reactor finishing process; pelletizing the blend of PPA and linear low density polyethylene resin; and, extruding the blend into a blown film or cast film on an extrusion line, wherein the polymer processing aid is a high molecular weight ethoxylate; and wherein the blown film or cast film is such that at 90 minutes of forming the blown film or cast film, % melt fracture (on basis of area of the film's surface) is less than equal to 35%.

### DETAILED DESCRIPTION OF THE INVENTION

The present disclosure relates to LLDPE compositions, including pellets, blown films and cast films, containing inventive polymer processing aids (PPAs) to help decrease and eliminate melt fracture during film processing. The LLDPE compositions containing the PPAs provided herein are substantially free of fluoropolymer compounds. Also provided are polyolefin masterbatches including such inventive PPAs. Still also provided are methods of making such LLDPE compositions containing non-fluorinated PPAs and methods of decreasing melt fracture in linear low density polyethylene films produced with such inventive PPAs.

It has been surprisingly and unexpectedly discovered that certain non-fluorine containing compounds decrease melt fracture % in blown LLDPE films and cast LLDPE films during extrusion processing. More particularly, the addition of high molecular weight ethoxylates has been surprisingly discovered to be highly effective as polymer processing aids relative to traditional fluoropolymer-based polymer processing aids. In particular, the inventive PPAs comprising high molecular weight ethoxylates herein when incorporated into LLDPE blown film and LLDPE cast film during extrusion processing result in a blown film or cast film such that at 90 minutes of forming the blown film or cast film, % melt fracture (on basis of area of the film's surface) is less than equal to 90%, or less than or equal to 80%, or less than or equal to 70%, or less than or equal to 60%, or less than or equal to 50%, or less than or equal to 40%, or less than or equal to 35%, or less than or equal to 30%, or less than or equal to 25%, or less than or equal to 20%, or less than or equal to 15%, or less than or equal to 10%, or less than or equal to 5%, or less than or equal to 1%, or 0% (no melt fracture whatsoever). Alternatively, the inventive PPAs disclosed herein decrease melt fracture % when incorporated into polyethylene that is extruded as a pipe, or wire and cable sheath or covering.

It has been surprisingly and unexpectedly discovered that the use of certain high molecular weight ethoxylate compounds decreases dye build up during the preparation of blown LLDPE films and cast LLDPE films during extrusion processing.

The details of the inventive PPAs, polyolefin masterbatches including such inventive PPAs, LLDPE compositions including such inventive PPAs, methods of making such LLDPE compositions and polyolefin masterbatches, methods of decreasing melt fracture in linear low density polyethylene films and methods of reducing dye build up are provided below.

### Definitions

For the purposes of the present disclosure, various terms are defined as follows.

The term “alpha-olefin” or “α-olefin” refers to an olefin having a terminal carbon-to-carbon double bond in the structure thereof R¹R²C═CH₂, where R¹ and R² can be independently hydrogen or any hydrocarbyl group; such as R¹ is hydrogen and R² is an alkyl group. A “linear alpha-olefin” is an alpha-olefin wherein R¹ is hydrogen and R² is hydrogen or a linear alkyl group. For the purposes of the present disclosure, ethylene shall be considered an α-olefin.

The term “extrusion” or “extruding” refers to processes that include forming a polymer and/or polymer blend into a melt, such as by heating and/or shear forces, and then forcing the melt out of a die in a form or shape such as in a film, or in strands that are pelletized. Typical extrusion apparatus includes a single-screw extruder or twin-screw extruder, or other melt-blending device as is known in the art and that can be fitted with a suitable die. It will also be appreciated that extrusion can take place as part of a polymerization process (in particular, in the finishing portion of such process) as part of forming polymer product (such as polymer pellets); or it can take place as part of the process for forming articles such as films from the polymer pellets (e.g., by at least partially melting the pellets and extruding through a die to form a sheet, especially when combined with blowing air such as in a blown film formation process). In the context of the present disclosure, extrusion in the finishing portion of polymerization processes may be referred to as compounding extrusion, and typically involves feeding additives plus additive-free (reactor grade) polymer to the extruder; while extrusion of polymer to make articles (e.g., extrusion of polymer pellets to make films) takes place downstream (e.g., at a later point, after polymer product has been formed including through compounding extrusion), and typically involves feeding optional additives plus additive-containing polymer to the extruder.

The term “finishing” refers to post-polymerization reactor processing steps where additives, such as PPAs, may be incorporated into the LLDPE polymer to form a finished polymer product, such as LLDPE pellets or resin, with one example of a finishing process being the compounding extrusion just discussed. Finishing occurs prior to further processing of the finished LLDPE polymer product (resin or granules) into articles such as films.

The term “LLDPE” refers to a linear-low density polymer containing a copolymer of ethylene and one or more α-olefins polymerized in the presence of one or more single-site catalysts, such as one or more Ziegler-Natta catalysts, one or more metallocene catalysts, and combinations thereof. Such LLDPE can have density within the range from a low of 0.900, 0.905, 0.907, 0.910 g/cm3 to a high of 0.920, 0.925, 0.930, 0.935, 0.940, to a high of 0.945 g/cm³. In particular embodiments, the LLDPE includes a metallocene-catalyzed LLDPE (mLLDPE). In yet other embodiments, the LLDPE includes a Ziegler-Natta catalyzed LLDPE (or ZN-LLDPE). LLDPE can be produced in gas, slurry, or solution phase polymerization, and some particularly preferred LLDPEs can be produced in gas or slurry phase polymerization.

The term “LLDPE composition” refers to a composition containing a LLDPE polymer. The LLDPE polymer composition can be in any form. Some examples include: the form of a reactor grade (e.g., granules or resin) containing the LLDPE polymer; the form of a molten or at least partially molten composition containing the LLDPE polymer and one or more additives undergoing or about to be undergoing the process of finishing (such as in the process of compounding extrusion), which is may be referred to as a pre; in the form of a finished LLDPE polymer product such as LLDPE polymer pellets containing the LLDPE and any additives (such as PPA); or in the form of a finished LLDPE product such as LLDPE resin undergoing the process of mixing (e.g., via coextrusion, melt blending, or other processing) with additives, such as in the case of LLDPE being extruded to form blown film, cast film or other polymer-containing article. In various embodiments, polymer compositions include one or more polymers, preferably polyolefin polymers.

The term “masterbatch” refers to a powdered, granulate, or pelletized composition comprising a mixture of two or more components that is used to simplify forming a product comprising the two components, rather than forming the product from the individual components. In addition, as used herein, the term encompasses both concentrated compositions, which are formulated to be mixed with one or more diluting components during the formation of the polymer product, or “fully” compounded compositions, which are not formulated to be mixed with such diluents. Unless context otherwise suggests, the phrase “MB” is used herein to denote “masterbatch.”

The term “melt fracture” refers to a mechanically-induced melt flow instability which occurs, e.g., at the exit of an extrusion die and typically in conditions of high shear rate. Pinhole, linear, and annular die geometries are among those that can induce melt fracture. There are different mechanical regimes that describe LLDPE melt fracture, but all manifest as a very rough polymer surface which persists as the polymer crystallizes. Commonly in the blown film processing, a rough array of sharkskin like patterns develop on the film surface, often with a characteristic size from the mm to cm scale, and they depend on both the flow profile and rheology of the LLDPE polymer.

The term “polyolefin” refers to polymers (including biopolymers) formed from at least one simple olefin (with the general formula CₙH₂ₙ) as a monomer, and includes both homopolymers and copolymers, (e.g., bipolymers, terpolymers, etc.), and blends thereof. In addition, they include polymers of ethylene (i.e., polyethylene), which include LDPE, LLDPE, MDPE, HDPE, copolymers of ethylene with one or more alpha-olefins, copolymers of ethylene with a vinyl ester comonomer, and blends thereof. They also include polymers of propylene (i.e., polypropylene), copolymers (e.g., bipolymers, terpolymers, etc.) of propylene with one or more alpha-olefins, and blends of different polyolefins. They also include polymers of butylene (i.e., polybutene), copolymers (e.g., bipolymers, terpolymers, etc.) of butylene with one or more alpha-olefins, and blends of different polyolefins. For purposes herein, a polymer or copolymer that is referred to as comprising an olefin means that the olefin present in such polymer or copolymer is the polymerized form of the olefin.

### Polymer Processing Aids (PPAs)

The present disclosure provides for inventive PPAs that may be incorporated into LLDPE compositions to improve their processing and productivity performance, as well as the quality of products in terms of visual appearance (e.g., blown films, cast films, etc.) that may be made from such LLDPE compositions. The inventive PPAs may be incorporated or blended into the LLDPE as part of a finishing step after the polymerization process or alternatively may be incorporated into LLDPE during the subsequent converting step to form a finished product, such as a blown film or a cast film. The PPAs and the corresponding LLDPE compositions incorporating such PPAs of the present disclosure are “substantially free” of fluoropolymer compounds, which means that the LLDPE compositions may include trace amounts (e.g., 10 ppm or less, preferably 1 ppm or less, such as 0.1 ppm or less) of fluorine, e.g., as an impurity, but well below the amount that would intentionally be included in a polymer composition via such additives (e.g., about 100 ppm of fluorine atoms by mass of polymer product in a typical case where such additives are included). The inventive high molecular ethoxylate PPAs of the present disclosure are described in detail below:

### High Molecular Weight Ethoxylate PPAs

The present invention utilizes high molecular weight (HMW) ethoxylates which, as noted, can help to reduce or eliminate melt fractures, as well as reducing the pressure and die build up in the preparation of blown and cast films. The HMW ethoxylates of the present invention typically range from C20-C50, having an ethylene oxide content of 20-90% by wt. Exemplary HMW ethoxylates include, but are not limited to, Unithox 420, Unithox 450 and Unithox 490.

The HMW ethoxylate can be added in masterbatch applications in an amount of up to 20% by weight, alternatively up to 10% by weight, alternatively between 2.0 and 7.5% by weight, alternatively between 4 and 6% by weight, alternatively between 3 and 5% by weight, alternatively between 5 and 7% by weight. In certain embodiments, the HMW ethoxylate is present in the finished film in an amount of between 100 and 5000 ppm, alternatively between 200 and 4000 ppm, alternatively between 300 and 3000 ppm.

In certain embodiments, the HMW ethoxylate PPAs of the present invention can be used in conjunction with other known PPAs. For example, polyethylene glycols (PEGs) can be used a PPA synergist. In certain embodiments, the LLDPE compositions disclosed herein may include one or more PEG-based compositions comprising at least 2 wt. % PEG, or at least 5 wt. % PEG, or at least 10 wt. % PEG, or at least 20 wt. % PEG, such as at least 30 wt. %, or at least 40 wt. % PEG where the LLDPE-based PPA composition is in the form of a masterbatch.

### Methods of Blending High Molecular Weight Ethoxylates PPAs Into LLDPE Compositions

Methods of introducing or blending the inventive high molecular weight ethoxylate PPAs into LLDPE compositions of the instant disclosure include adding the inventive PPA neat or, equivalently, a masterbatch of the high molecular weight ethoxylate PPA to LLDPE composition (e.g., polymer granules and/or slurry) exiting a polymerization reactor to form a pre-finished polymer mixture in or upstream of a compounding extruder. The pre-finished polymer mixture therefore includes the LLDPE polymer and high molecular weight ethoxylate PPA composition (both per above respective descriptions), as well as any optional other additives (which may be provided to the mixture along with, before, or after the high molecular weight ethoxylate PPA). The pre-finished LLDPE polymer mixture may, for example, be a polymer melt (e.g., formed in or just upstream of a compounding extruder). The LLDPE mixture is then extruded and optionally pelletized to form a further LLDPE polymer composition (e.g., LLDPE polymer pellets) comprising the above described high molecular weight ethoxylate PPA and LLDPE polymer (each per above, and with the high molecular weight ethoxylate PPA in amounts in accordance with the above discussion), as well as any optional other additive(s) described below.

Also or instead, methods may include mixing finished LLDPE polymer (e.g., LLDPE pellets) with an HMW ethoxylate PPA (either neat or as a masterbatch) to form a LLDPE mixture; and processing the LLDPE mixture to form a LLDPE blown film or a LLDPE cast film. Such processing may be in accordance with well-known methods in the art, and in particular in accordance with blown film and cast film extrusion.

Hence, more generally, methods of the present disclosure can include: blending the HMW ethoxylate PPA described above (neat or as a polyolefin masterbatch) with a LLDPE composition to form a LLDPE mixture, and forming the LLDPE mixture into a LLDPE product. The blending can be carried out as part of a finishing process (e.g., wherein the LLDPE composition is a reactor-grade LLDPE polymer such as granules; and the LLDPE product comprises polymer pellets, and then providing a ready-to-use LLDPE resin product for making films or other polymeric articles). Or, the blending of the inventive PPA can be carried out as part of a process for forming LLDPE articles such as films—for example, wherein the LLDPE composition is a finished polymer composition such as LLDPE resin or pellets; and the LLDPE product comprises a LLDPE article such as a film. Such processes highlight a flexible approach, wherein LLDPE pellets or other finished LLDPE product without PPA are made ready for blown film or other article production through addition of the inventive PPA compositions described above (e.g., neat or masterbatch).

The inventive PPAs described above are particularly advantageous in reducing and/or eliminating melt fracture in blown LLDPE films. When the HMW ethoxylate PPAs disclosed herein are used to produce LLDPE blown films, the films will exhibit similar or superior properties compared to LLDPE films comprising conventional fluoropolymer based PPAs. This also exemplifies embodiments of the present disclosure including high molecular weight ethoxylate PPA masterbatches, which could make for flexible LLDPE products ready for addition to any number of finished LLDPE products as needed for article production.

### Other Additives

Other additives optionally may be present in the LLDPE compositions including the inventive PPAs disclosed herein. These other additives may include antioxidants, stabilizers such as UV stabilizers, catalyst neutralizers, as well as, slip agents, antiblock agents, heat seal enhancing additives, clarifying agents, and other additives known in the art of polymerization, compounding and film or pipe extrusion.

Additive packages including a combination of one or more additives in a carrier resin may also be used. For example, an additive package including antiblock and/or slip agents, potentially along with other additives. Non-limiting exemplary antiblock agents for the LLDPE compositions disclosed herein include talc, crystalline and amorphous silica, nepheline syenite, diatomaceous earth, clay, or combinations thereof. Non-limiting exemplary slip agents for the LLDPE compositions disclosed herein include amides such as erucamide and other primary fatty amides like oleamide; and further include certain types of secondary (bis) fatty amides.

Antiblock agent loadings in the LLDPE compositions disclosed herein may be from 500 to 6000 ppm, or 1000 to 5000 ppm. Slip agent loadings in the LLDPE compositions disclosed herein may be 200 to 1000 ppm, or 400 to 2000 ppm, or 600 to 3000 ppm. Other additives may also be included in the LLDPE compositions disclosed herein, for example the following: fillers; antioxidants (e.g., hindered phenolics such as IRGANOX™ additives available from Ciba-Geigy); tackifiers, such as terpene resins, aliphatic and aromatic hydrocarbon resins, alkali metal and glycerol stearates, and hydrogenated rosins; UV stabilizers; heat stabilizers; release agents; anti-static agents; pigments; colorants; dyes; waxes; silica; fillers; talc; and combinations thereof. Where such other additives are utilized in the LLDPE compositions disclosed herein, they are also preferably free or substantially free of fluorine.

In certain embodiments, the HMW ethoxylate containing polymer masterbatch may be produced by melting and mixing a polyolefin carrier resin (e.g., LDPE, LLDPE, HDPE, HPP, co-PP, or a similar polymer) and the HMW ethoxylate at sufficient temperatures above the melting temperature of the polymer, typically at least greater than 150° C., more typically between 190-240° C., depending on the polymer. The mixing may be achieved by known means, including a compounding extruder, continuous mixer, or batch mixer to homogeneously mix the ethoxylate into the polymer carrier. The compound may be strand cut or underwater cut coming out of the extruder for optimal pellets for feeding at the converter.

In certain embodiments, the masterbatch may include 2-20% by weight of the HMW ethoxylate for optimal letdown rates at the converter. In certain embodiments, the active concentration of ethoxylate for film applications is between approximately 500 and 3000 ppm (i.e., a 5% by weight masterbatch letdown at 1-5% by weight by the film converter). Optionally, additional additives may be added to the masterbatch. For example, a primary and/or secondary antioxidant may be added to the masterbatch in the range of between approximately 0.05-0.2% by weight for improved thermal stability of the masterbatch during and after processing. The antioxidant may be pre-mixed with a ground powder of the polyolefin carrier prior to melt compounding for improved feeding accuracy during the masterbatch compounding. Other additives that may be provided to the masterbatch compounding process may include, but are not limited to, stearates, slip agents, antistatic agents, antiblocking agents, UV additives, acid neutralizers.

The melt flow range of the HMW ethoxylate masterbatch may vary based on the converter process, but is usually targeted at between 1.0-10.0 g/10 min at 2.16 kg/190° C. for polyethylene masterbatches and between 5.0-20.0 g/10 min at 2.16 kg/230° C. for polypropylene masterbatches. These melt flow ranges may be achieved for polyethylene masterbatches by using a 2.0 MI LDPE (e.g., Petrothene NA 951000 or LD100.BW) or 2.0 MI LLDPE (e.g., Petrothene GA502024 or LL1002.09). Higher melt flow LDPE or LLDPE may be added in the range of 5-40% by weight as an MI adjustor for the finished masterbatch as well as for improved pellet appearance. For HPP masterbatches, combinations of 3 MI HPP (e.g., Profax PH350, Profax HP525J, PP 4,712 E1) and 12 MI HPP (e.g., Profax 6301) may be used to achieve the desired final melt flow. For co-PP masterbatches, 7 MI co-pp (e.g., DS6D82) may be used. Likewise combinations of other MI resins may be used at various ratios to achieve the desired melt flow rate of the masterbatch.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

In a first example, a polymer masterbatch was prepared by mixing approximately 94.6% by weight of a LLDPE polyethylene homopolymer, 5% by weight Unithox 490, 0.2% by weight of a phenolic antioxidant, and 0.2% by weight of a phosphite antioxidant.

### Example 2

In a second example, a polymer masterbatch was prepared by mixing approximately 94.8% by weight of a polypropylene homopolymer, 5% by weight Unithox 490, 0.05% by weight of a phenolic antioxidant, and 0.15% by weight of a phosphite antioxidant.

### Example 3

In a third example, a polymer masterbatch was prepared by mixing approximately 94.8% by weight of a random polypropylene copolymer, 5% by weight Unithox 490, 0.05% by weight of a phenolic antioxidant, and 0.15% by weight of a phosphite antioxidant.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of the ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A linear low density polyethylene (LLDPE) composition comprising a LLDPE polymer and from 100 ppm to 10,000 ppm of a high molecular weight ethoxylate polymer processing aid (PPA).

2. The LLDPE composition of claim 1, wherein the LLDPE polymer is a metallocene-catalyzed LLDPE, a Ziegler Natta-catalyzed LLDPE, or combinations thereof.

3. The LLDPE composition of claim 1, wherein the composition is in the form of resin pellets, an article, a blown film or a cast film.

4. The LLDPE composition of claim 3, wherein the blown film or cast film is such that at 90 minutes of forming the blown film or cast film, % melt fracture (on basis of area of the film's surface) is less than equal to 35%.

5. The LLDPE composition of claim 1, wherein the high molecular weight ethoxylate polymer processing aid is from 500 to 5000 ppm of the composition.

6. The LLDPE composition of claim 1 further including one or more additives selected from the group consisting of UV stabilizers, catalyst neutralizers, slip agents, antiblock agents, heat seal enhancing additives, fillers, antioxidants, tackifiers, aliphatic and aromatic hydrocarbon resins, alkali metal and glycerol stearates, hydrogenated rosins, heat stabilizers, release agents, anti-static agents, pigments, colorants, dyes, silica, talc, and waxes.

7. A polyolefin masterbatch comprising a polyolefin polymer and from 1 wt. % to 50 wt. % of a high molecular weight ethoxylate polymer processing aid (PPA) that is substantially free of fluorine-containing compounds.

8. The polyolefin masterbatch of claim 7, wherein the polyolefin polymer is selected from the group consisting of LLDPE; LDPE; MDPE; HDPE; PP; PB-1; copolymers and terpolymers of ethylene, propylene and butylene; and combinations thereof.

9. The polyolefin masterbatch of claim 7 further including one or more additives selected from the group consisting of UV stabilizers, catalyst neutralizers, slip agents, antiblock agents, heat seal enhancing additives, fillers, antioxidants, tackifiers, aliphatic and aromatic hydrocarbon resins, alkali metal and glycerol stearates, hydrogenated rosins, heat stabilizers, release agents, anti-static agents, pigments, colorants, dyes, silica, talc, and waxes.

10. The polyolefin masterbatch of claim 7, wherein the masterbatch is blended into a LLDPE blown film or cast film extrusion process to provide a loading of 100 ppm to 10,000 ppm of the polymer processing aid in the blown film or cast film, and such that at 90 minutes of forming the blown film or cast film, % melt fracture (on basis of area of the film's surface) is less than equal to 35%.

11. A method of decreasing melt fracture in linear low density polyethylene films comprising:
extruding a linear low density polyethylene resin into a blown film or cast film on an extrusion line; and
blending into the extrusion line a high molecular weight ethoxylate polymer processing aid (PPA) that is substantially free of fluorine-containing compounds to provide from 100 ppm to 10,000 ppm of the polymer processing aid (PPA) in the blown film or the cast film; and
wherein the blown film or cast film is such that at 90 minutes of forming the blown film or cast film, % melt fracture (on basis of area of the film's surface) is less than equal to 35%.

12. The method of claim 11, wherein the polymer processing aid is directly blended into the extrusion line or blended into the extrusion line as a masterbatch.
